(19) United States
(12) Patent Application Publication
(10) Pub. No.: US 2016/0097308 A1
(43) Pub. Date: Apr. 7, 2016

(54) CRANKCASE VENTILATION SYSTEM

(71) Applicant: Electro-Motive Diesel, Inc., LaGrange, IL (US)

(72) Inventors: Raji REXAVIER, Plainfield, IL (US); Stuart Leighton BELL, Chicago Heights, IL (US)

(73) Assignee: Electro-Motive Diesel, Inc., LaGrange, IL (US)

(21) Appl. No.: 14/508,887

(22) Filed: Oct. 7, 2014

(51) Int. Cl. F01M 13/04; F01M 13/00; F02B 37/00; F01M 13/02

(52) U.S. Cl. CPC F01M 13/04; F01M 13/028; F01M 13/0011; F02B 37/005

(57) ABSTRACT

A ventilation system is disclosed for use with an engine having a crankcase The ventilation system may have a first source of compressed air and a second source of compressed air. The ventilation system may also have a plurality of oil separators, each in separate communication with the crankcase. The ventilation may system further have a distribution manifold in fluid communication with the plurality of oil separators, and a shuttle valve fluidly connected between the distribution manifold and the first and second sources of compressed air.

### TECHNICAL FIELD

The present disclosure relates generally to a ventilation system and, more particularly, to a system for ventilating a crankcase of an internal combustion engine.

### BACKGROUND

An internal combustion engine typically includes an engine block that at least partially defines one or more cylinders. A piston is reciprocatingly disposed within each cylinder and, together with a cylinder head, forms a combustion chamber. A mixture of fuel and air is introduced into the combustion chamber and is compressed by the piston in preparation for combustion. When combustion takes place, the expanding gases force the piston downward to rotate a connected crankshaft, thereby converting chemical energy into kinetic energy.

During a compression stroke of the piston and during combustion, some of the compressed and expanding gases leak through a necessary clearance between the piston and cylinder and into a space below (i.e., into a crankcase). This leakage of gases is commonly known as “blow-by”. During operation of the engine, the blow-by gases build within the crankcase, resulting in a high-pressure region that acts against movement of the piston and reduces engine efficiency.

Crankcase ventilation systems are typically employed so as to reduce the pressure in the crankcase. In particular, gases from the crankcase are vented to the atmosphere. In some applications, these gases can have oil entrained therein that should not be discharged. For this reason, oil separators are commonly used to separate oil from the gases prior to discharge and to return the oil to the crankcase. Some oil separators draw blow-by gases from the crankcase of an engine using a vacuum produced with compressed air from an engine's turbocharger or from another compressed air source, such as an air compressor powered by the crankshaft of the engine.

An exemplary crankcase ventilation system is disclosed in international patent application PCT/EP2009/003751 of Kölmel et al. that published as WO2009156036 (the '036 publication) on Dec. 30, 2009. The '036 publication discloses an engine having dual cylinder banks and a crankcase ventilation system with multiple oil separators. Each cylinder bank is assigned an oil separator and a dedicated air induction system having a turbocharger, intercooler, and conduits connecting the oil separator to the air induction system. The crankcase ventilation system includes a conduit leading from the engine's crankcase to the oil separator, where gas is separated from oil and drawn through one of two paths into the air induction system. A vacuum produced upstream of the turbocharger compressor draws gas through the first path, and a vacuum produced downstream of the turbocharger compressor draws gas through the second path. Valves at the exit of the oil separators direct separated gas toward the path having the stronger vacuum, depending on load conditions of the engine. Oil collected in the separators is returned to the crankcase through an oil return conduit.

Although perhaps somewhat effective at venting a crankcase, the system of the '036 publication may be bulky and consume too much space on the assembled engine. In addition, because each cylinder bank relies on pressurized air from only a single source (i.e. from a turbocharger), the ventilation system of the '036 publication may lack sufficient vacuum in some situations.

The disclosed ventilation system is directed to overcoming one or more of the problems set forth above.

### SUMMARY

In one aspect, the present disclosure is directed to a ventilation system for use with an engine having a crankcase. The ventilation system may include a first source of compressed air and a second source of compressed air. The ventilation system may also include a plurality of oil separators, each in separate communication with the crankcase. The ventilation system may further include a distribution manifold in fluid communication with the plurality of oil separators, and a shuttle valve fluidly connected between the distribution manifold and the first and second sources of compressed air.

In another aspect, the present disclosure is directed to a method of venting a crankcase. The method may include directing fluid from the crankcase to a plurality of oil separators in parallel. The method may also include pressurizing air at a first location and at a second location, and selectively diverting pressurized air from the first location or from the second location to the plurality of oil separators.

### BRIEF DESCRIPTION OF THE DRAWING

FIG. 1 is an illustration of an engine equipped with an exemplary disclosed crankcase ventilation system; and

FIG. 2 is a diagrammatic illustration of an exemplary air supply circuit that may be used with the crankcase ventilation system of FIG. 1.

### DETAILED DESCRIPTION

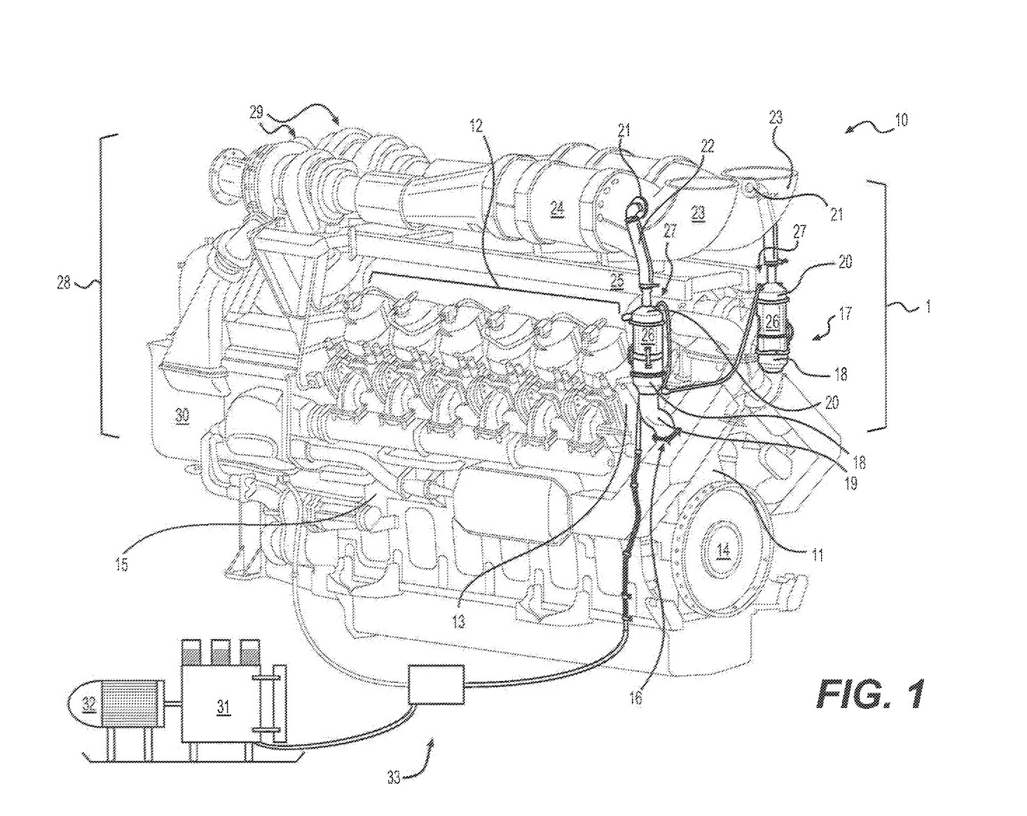

FIG. 1 illustrates an exemplary crankcase ventilation system 1 used with an internal combustion engine 10. One skilled in the art will recognize that engine 10 may be any type of internal combustion engine such as, for example, a diesel engine, a gasoline engine, or a gaseous fuel-powered engine. Engine 10 may include an engine block 11 that at least partially defines one or more cylinder banks 12 and a plurality of cylinders. Each cylinder bank 12 includes one or more cylinders, in which a piston is slidably disposed (not shown in FIG. 1). A cylinder head 13 may connect to engine block 11 to cap off an end of each cylinder. Each cylinder and piston may come together with cylinder head 13 to form a combustion chamber (not shown in FIG. 1). Engine 10 may include any number of combustion chambers, and combustion chambers may be disposed in an “in-line” configuration, a “V” configuration, or in any other suitable configuration.

Engine 10 may also include a crankshaft 14 that is rotatably disposed within engine block 11. A connecting rod (not shown in FIG. 1) may connect each piston to crankshaft 14 so that a sliding motion of each piston within each respective cylinder results in a rotation of crankshaft 14. The Pistons may reciprocate through an intake stroke, a compression stroke, a combustion or power stroke, and an exhaust stroke to complete an engine cycle.

A cavity known as a crankcase 15 may at least partially be defined by engine block 11 below the combustion chambers. Lubricant, for example engine oil, may be provided from crankcase 15 to internal engine surfaces to reduce metal-on-metal contact and thereby inhibit damage to the surfaces. Crankcase 15 may serve as a sump for collecting and supplying this lubricant.

During the compression and power strokes of engine 10, some of the compressed and expanding gases may leak from the combustion chambers through a necessary clearance between each piston and cylinder into the crankcase. The leaked gases are referred to as blow-by gases. The blow-by gases may become entrained with lubricant in crankcase 15 and increase the pressure therein. Crankcase vents 16 may be provided to relieve blow-by gases from the crankcase into the atmosphere.

The venting of blow-by gases to the atmosphere may be regulated to reduce the discharge of pollutants. To comply with these regulations, at least one oil separator 17 may be connected to each crankcase vent 16 for separating entrained lubricant from blow-by gases before venting only the gases to the atmosphere. As seen in FIG. 1, two oil separators 17 are fluidly connected to crankcase 15, with one oil separator 17 assigned to each cylinder bank 12. Other configurations may also be possible. After lubricant is separated from the blow-by gases in oil separator 17, the lubricant may be returned to crankcase 15 instead of being discharged to the atmosphere with the blow-by gases.

Crankcase vents 16 and oil separators 17 may be located near an end of each cylinder bank 12 at a rear end of engine 10. Oil separators may have a single gas inlet 18 for receiving fumes from crankcase 15. Inlets 18 of oil separators 17 may be fluidly connected to crankcase vents 16 by conduits 19. Outlets 20 of oil separators 17 may be fluidly connected to blow-by gas vents 21 via outlet conduits 22. An engine exhaust pipe and after-treatment system 24 may be located above engine 10, and blow-by gas vents 21 may be extended into and communicate with after-treatment system 24. In this configuration, conduits 19 and 22 may be oriented substantially vertically.

Oil separator inlets 18 and outlets 20 may each be independently mounted rearward of cylinder heads 13. In this way, a filter housings 26 of oil separators 17 may also remain rearward of cylinder banks 12. Inlets 18 and outlets 20 may be mounted to an existing support structure 25 on engine 10 to avoid the use of additional mounting materials. Support structure 25 may be any suitable structure on engine 10. Filter housings 26 may fluidly connect oil separator inlets 18 to oil separator outlets 20. Filter housing 26 may also be detachable therefrom without decoupling any other connections within crankcase ventilation system 1.

Oil separators 17 may include a filter media located within filter housing 26 for separating lubricants from blow-by gases. Separated oil may be trapped by the filter media while blow-by gases may pass through the filter media before being vented to the atmosphere. Oil trapped within the filter media may accumulate and subsequently flow back downward into crankcase 15 through inlet 18, inlet conduit 19, and crankcase vent 16. In this way, oil separators 17 may not require additional fittings or conduits to return separated oil to crankcase 15. Gas flow through oil separators 17 may follow a substantially vertical path from crankcase vents 16 to oil separator inlets 18, and oil may return to crankcase 15 along the same substantially vertical path.

Oil separators 17 may use compressed air to generate a vacuum for drawing blow-by gases from crankcase 15. For example, a compressed air inlet 27 may fluidly connect a compressed air supply to a venturi located within filter housing 26 of each oil separator 17 to create a low-pressure space therein. The low-pressure space may be fluidly connected to crankcase vent 16 through filter housing 26 and inlet conduit 19, thereby creating a vacuum that draws fumes from crankcase 15 into oil separators 17. Accordingly, the supply of pressurized air to oil separators 17 may create negative pressure inside crankcase 15. Negative pressure may be maintained in crankcase 15 by continuously supplying oil separators 17 with a sufficient flow rate of compressed air at a sufficient pressure.

An air supply circuit 33 may supply crankcase ventilation system 1 with compressed air. Air supply circuit 33 may include an air induction system 28 of engine 10, which may include one or more turbochargers 29 driven by engine exhaust, and a charge air cooler 30. Air supply circuit 33 may also include an air compressor 31. Air compressor 31 may be any suitable type of air compressor and may be driven with power generated by engine 10. For example, air compressor 31 is depicted in FIG. 1 as being driven by an electric motor 32 with electricity generated by engine 10. However, it is also contemplated that air compressor 31 may be mounted on engine 10 and driven by crankshaft 14.

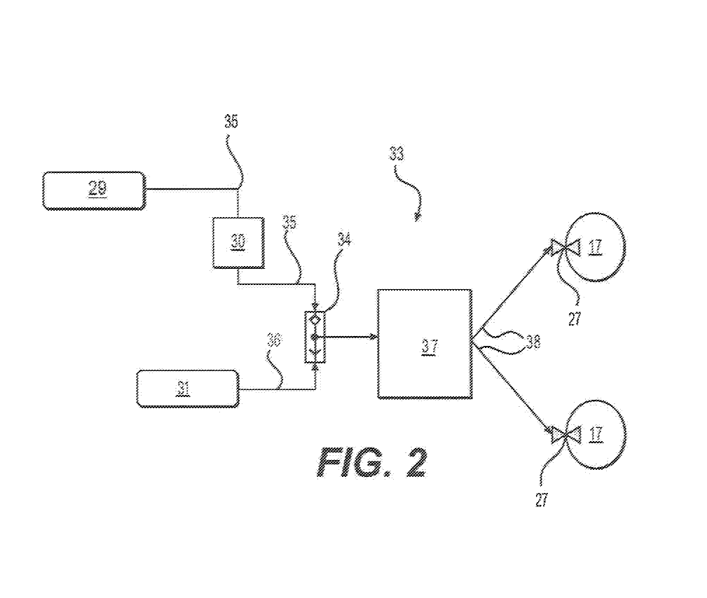

FIG. 2 diagrammatically illustrates an exemplary layout of air supply circuit 33 that may be used to pressurize supply compressed air to crankcase ventilation system 1. Air supply circuit 33 may include a first source of compressed air at a first location and a second source of compressed air at a second location. For example, the first source of compressed air may be turbocharger 29 of engine 10, and the second source of compressed air may be an air compressor 31. A person of ordinary skill in the art may contemplate other or additional suitable sources of compressed air.

Turbocharger 29 and air compressor 31 may be fluidly connected to a single shuttle valve 34 via first and second air supply conduits 35 and 36 respectively. Charge air cooler 30 of engine 10 may be fluidly connected between turbocharger 29 and the shuttle valve 34. Shuttle valve 34 may be fluidly connected to compressed air inlets 27 of oil separators 17 via a distribution manifold 37 and distribution lines 38. Shuttle valve 34 may be configured to selectively divert compressed air from either first compressed air source or second compressed air source to distribution manifold 37. Shuttle valve 34 may divert the compressed air based on a pressure of each compressed air source. For example, shuttle valve 34 may be configured to divert compressed air from a higher-pressure one of the first and second compressed air sources to distribution manifold 37.

Air pressure from the first and second air sources may vary over a power output range of engine 10. For example, air pressure from the first location may be higher when a power output of engine 10 is equal to or greater than about 30-40% of its maximum rated power. Alternatively, air pressure from the second location may be higher when the power output of engine 10 is below about 30-40% of its maximum rated power. In this way, the supply of compressed air from a combination of the first and second air sources through shuttle valve 34 to distribution manifold 37 during operation of engine 10 may be substantially constant.

Distribution manifold 37 may be fluidly connected to two or more oil separators 17 of crankcase ventilation system 1. Distribution manifold 37 may deliver a substantially constant supply of compressed to each oil separator 17. While two oil separators 17 are shown in FIGS. 1 and 2, a person of ordinary skill in the art would appreciate that any number of oil separators 17 may be used. Oil separators 17 may each have a single respective compressed air inlet 27 separately connected to distribution manifold 37 by distribution lines 38.

### INDUSTRIAL APPLICABILITY

The disclosed crankcase ventilation system may be applicable to any combustion engine where the atmospheric discharge of blow-by gases is regulated, and where spatial constraints around the engine are important. The disclosed ventilation system may have a reduced footprint on the engine and also high efficiency in venting blow-by gases to the atmosphere. The operation of crankcase ventilation system 1 will now be discussed with reference to FIG. 2.

During operation of engine 10, a substantially constant supply of compressed air may be generated by two different sources at two different locations. For example, turbocharger 29 may be driven by exhaust gases of engine 10, and air compressor 31 may be an auxiliary air compressor. Compressed air from turbocharger 29 and air compressor 31 may be delivered to shuttle valve 34 through air supply lines 35 and 36 respectively. Compressed air from turbocharger 29 may pass through charge air cooler 30 before reaching shuttle valve 34 to cool the compressed air, which may have been heated by the turbocharger 29.

Shuttle valve 34 may constantly and selectively divert compressed air from turbocharger 29 and air compressor 31 to distribution manifold 37 based on pressure conditions at the first and second locations. In particular, shuttle valve 34 may selectively divert compressed air to distribution manifold 37 from the higher-pressure source.

Each oil separator 17 may receive the compressed air from distribution manifold 37 through a distribution line 38 at a single compressed air inlet 27. Oil separators 17 may use the compressed air to create and maintain a vacuum that draws blow-by gases from the crankcase 15 of engine 10 through crankcase vent 16. In particular, compressed air inlet 27 may direct compressed air to a venture (not shown in FIG. 2) located within filter housing 26 (referring to FIG. 1) of each oil separator 17 that creates a low-pressure space therein. The low-pressure space may create a vacuum that generates negative pressure in crankcase 15 and draws fumes from crankcase 15 into oil separators 17 through crankcase vents 16. Blow-by gasses drawn into oil separators 17 may be separated from entrained lubricants, such as engine oil, before being vented to the atmosphere. The separated lubricants may then be returned to the crankcase.

It will be apparent to those skilled in the art that various modifications and variations can be made to the disclosed ventilation system. Other embodiments will be apparent to those skilled in the art from consideration of the specification and practice of the disclosed ventilation system. It is intended that the specification and examples be considered as exemplary only, with a true scope being indicated by the following claims and their equivalents.

What is claimed is:

1. A ventilation system for use with an engine having a crankcase, the ventilation system comprising:
a first source of compressed air;
a second source of compressed air;
a plurality of oil separators, each configured to separately communicate with the crankcase;
a distribution manifold in fluid communication with the plurality of oil separators; and
a shuttle valve fluidly connected between the distribution manifold and the first and second sources of compressed air.

2. The ventilation system of claim 1, wherein the shuttle valve is configured to selectively connect the first or second source of compressed air to the distribution manifold based on a pressure of air from the first and second sources of compressed air.

3. The ventilation system of claim 2, wherein the shuttle valve is configured to connect a higher-pressure one of the first and second sources of compressed air to the distribution manifold.

4. The ventilation system of claim 3, wherein the first source of compressed air has a higher pressure when a power output of the engine is equal to or greater than about 30-40% of a maximum rated power.

5. The ventilation system of claim 4 wherein the second source of compressed air has a higher pressure when the power output of the engine is below about 30-40% of the maximum rated power.

6. The ventilation system of claim 3, wherein the first and second sources of compressed air are a turbocharger and a compressor, respectively.

7. The ventilation system of claim 6, wherein a charge air cooler is fluidly connected between the first source of compressed air and the shuttle valve.

8. The ventilation system of claim 1, wherein each of the plurality of oil separators is provided a substantially constant supply of compressed air from a combination of the first and second sources over a range of engine operation.

9. The ventilation system of claim 1, wherein a negative pressure is maintained within the crankcase during operation of the ventilation system.

10. The ventilation system of claim 1, wherein each of the plurality of oil separators includes a single gas inlet, and lubricant separated from crankcase gases is returned to the crankcase via the single gas inlet.

11. A method of venting a crankcase of an engine comprising:
directing fluid from the crankcase to a plurality of oil separators in parallel;
pressurizing air at a first location;
pressurizing air at a second location; and
selectively diverting pressurized air from the first location or from the second location to the plurality of oil separators.

12. The method of claim 1, wherein the pressurized air is selectively diverted from the first location or the second location to a distribution manifold connected to the plurality of oil separators.

13. The method of claim 12, wherein the pressurized air is selectively diverted based on air pressure from the first and second locations.

14. The method of claim 13, wherein pressurized air is selectively diverted from a higher-pressure one of the first and second locations.

15. The method of claim 14, wherein the first location has higher pressure when a power output of the engine is equal to or greater than about 30-40% of a maximum rated power.

16. The method of claim 15, the second location has higher pressure when the power output of the engine is below about 30-40% of the maximum rated power.

17. The method of claim 11, further including maintaining a negative pressure in the crankcase.

18. The method of claim 11, wherein selectively diverting pressurized air to the plurality of oil separators includes constantly diverting pressurized air to the plurality of oil separators during operation of the engine.

19. An engine comprising:
an engine block defining a plurality of cylinders;
a crankcase at least partially defined by the engine block;
a crankshaft rotatably connected to the engine block;
a turbocharger driven by exhaust from the plurality of cylinders to pressurize air;
a compressor driven with power generated by the engine to pressurize air;
a plurality of oil separators, each in fluid communication with the crankcase and having a compressed air inlet;
a distribution manifold fluidly connected to the compressed air inlet of each of the plurality of oil separators; and
a single shuttle valve disposed between the distribution manifold, the turbocharger, and the compressor.

20. The engine of claim 19, wherein the shuttle valve is configured to selectively divert pressurized air from a higher-pressure one of the turbocharger or the compressor to the plurality of oil separators.
